(19) United States
(12) Patent Application Publication
(10) Pub. No.: US 2019/0202195 A1
(43) Pub. Date: Jul. 4, 2019

(54) METHOD FOR MANUFACTURING LAMINATED PRINTED TAPES AND MACHINE FOR ITS EXECUTION

(71) Applicant: UTECO CONVERTING S.P.A., Colognola Ai Colli (IT)

(72) Inventors: Mario GAZZANI, San Pietro in Cariano (IT); Stefano RUSSO, Folgaria (IT); Dario CAMORANI, Castellarano (IT)

(73) Assignee: UTECO CONVERTING S.P.A., Colognola Ai Colli (IT)

(21) Appl. No.: 16/323,644

(22) PCT Filed: Aug. 3, 2017
(86) PCT No.: PCT/EP2017/069651

§ 371 Date: Feb. 6, 2019

(30) Foreign Application Priority Data
Aug. 8, 2016 (IT) 102016000083243

(51) Int. Cl. B41F 19/00

(52) U.S. Cl. CPC B41F 19/001; B41F 19/007; B41F 19/004

(57) ABSTRACT

A method for manufacturing laminated printed tapes, comprising the steps of:
causing the advancement of a primary tape, making it adhere, with at least one segment thereof, to the lateral surface of an entrainment drum;
performing at least one printing operation with application of at least one layer of ink on at least one portion of the segment of the primary tape in adhesion with the lateral surface of the entrainment drum; and
subsequently laminating, on the segment of the primary tape in adhesion with the lateral surface of the entrainment drum, a secondary tape by way of the interposition of adhesive material, so as to obtain a laminated printed tape.

The present invention relates to a method for manufacturing laminated printed tapes and a machine for its execution.

The use is known, in particular for the packaging of foods, of tapes produced by way of the mutual adhesive bonding of two or more flexible tape-like elements that have different characteristics, so as to obtain a tape that is capable of positively combining the characteristics of the individual tape-like elements that go to make it up.

Currently, production of these tapes occurs in at least two separate steps, using a discontinuous process.

In particular, the first step of the process consists in printing a primary tape on a rotary printing machine, typically of the flexographic type, so as to produce a series of reels of printed primary tape.

The second step of the process then consists in positioning each reel of printed primary tape, previously obtained, on a laminating machine that couples the printed primary tape to a secondary tape, by interposing a layer of adhesive, which can be solventless or water-based or solvent-based, thus obtaining a laminated printed tape which is collected on a reel.

Once the lamination has been executed between the printed primary tape and the secondary tape, the reel of laminated printed tape has to remain “at rest” for a certain time, a non-negligible period with respect to the process times, for the purpose of allowing the adhesive to take hold and, therefore, ensure a stable lamination between the two tapes.

Usually there is also a final step of the process, in which the reel of laminated printed tape is positioned on a cutting machine, which makes it possible to cut the laminated printed tape longitudinally so as to reduce it reels of narrower width than the starting reel.

This manufacturing process exhibits evident drawbacks both from the point of view of execution time and from the point of view of complexity of plant engineering.

The aim of the present invention is to provide a solution to the above mentioned problems, by devising a method that makes it possible to speed up the production of laminated printed tapes.

Within this aim, an object of the present invention is to provide a machine for manufacturing laminated printed tapes that is structurally simple and has reduced encumbrance.

Another object of the present invention is to provide a method for manufacturing laminated printed tapes and a machine for its execution that are competitive from a purely economic viewpoint as well.

This aim and these and other objects which will become better apparent hereinafter are achieved by a method for manufacturing laminated printed tapes and by a machine for its execution, according to the invention, as defined in claim 1 and in claim 10.

Further characteristics and advantages of the invention will become better apparent from the description of some preferred, but not exclusive, embodiments of the method and of the machine, according to the invention, which are illustrated, by way of non-limiting example, in the accompanying drawings wherein:

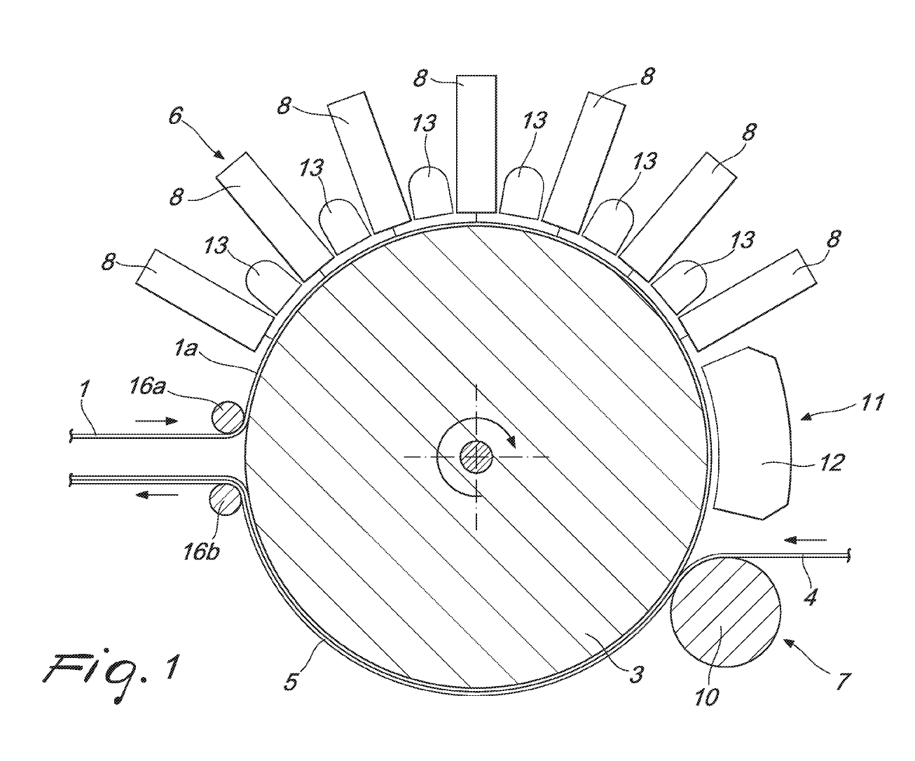

FIG. 1 is a schematic side view of a first embodiment of the machine according to the invention;

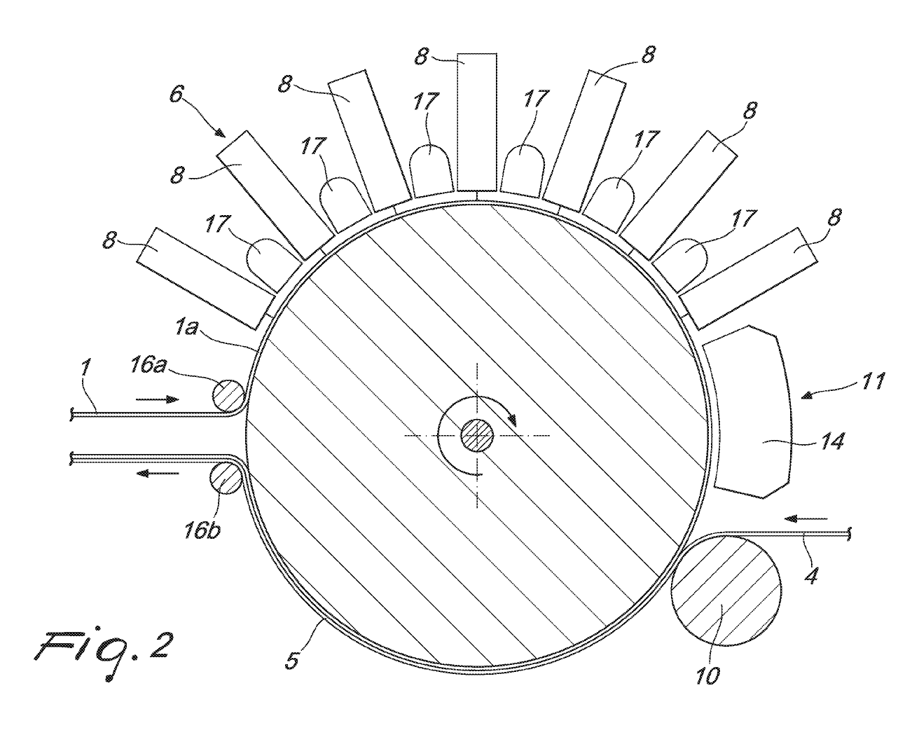

FIG. 2 is a schematic side view of a second embodiment of the machine according to the invention;

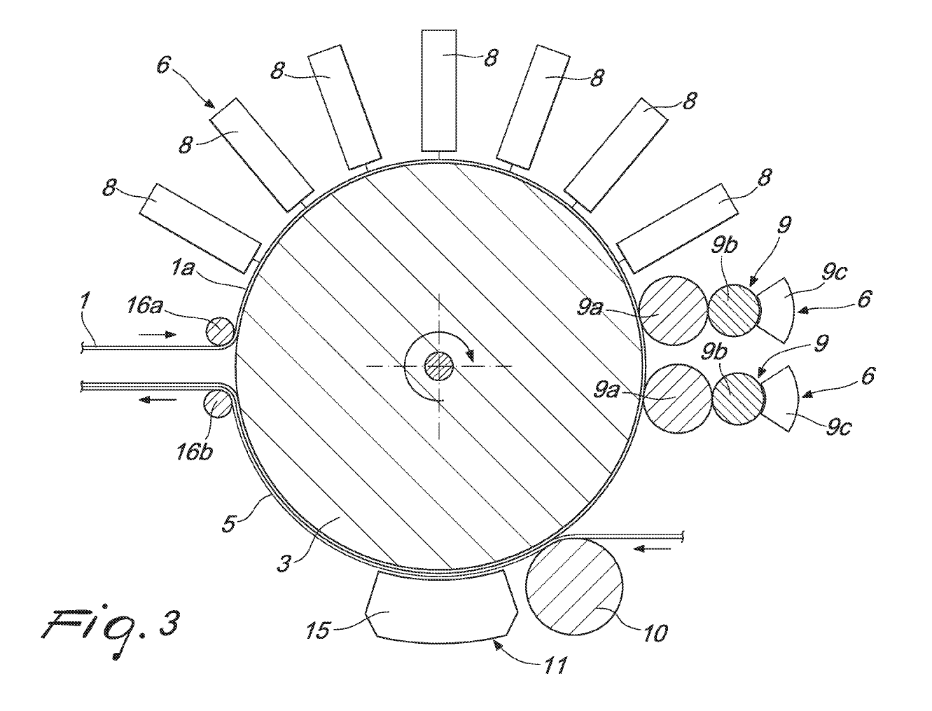

FIG. 3 is a schematic side view of a third embodiment of the machine according to the invention.

With reference to the figures, the method for manufacturing laminated printed tapes, according to the invention, entails causing the advancement of a primary tape 1, making it adhere, with at least one segment 1a thereof, to the lateral surface of an entrainment drum 3 and performing one or more printing operations, with application of at least one layer of ink, on the segment 1a of the primary tape 1 that is in adhesion with the lateral surface of the entrainment drum 3.

The method according to the invention further entails subsequently laminating, again on the segment 1a of the primary tape 1 that is in adhesion with the entrainment drum 3, a secondary tape 4, by way of the interposition of adhesive material, so as to obtain a laminated printed tape 5.

Advantageously, the method also provides for controlling the temperature at least of the segment 1a of the primary tape 1 that is in adhesion with the lateral surface of the entrainment drum 3, by way of the temperature control of that entrainment drum and, more specifically, of its lateral surface.

Preferably, again at the segment 1a of the primary tape 1 in adhesion with the lateral surface of the entrainment drum 2, at least one treatment is carried out on the layer of ink and/or on the adhesive material that were previously applied.

For example, such treatment can comprises at least one step of drying and/or polymerizing the layer of ink and/or the adhesive material.

It should be noted that the inks that can be used in the above printing operations can be chosen from the group that comprises: water-based inks; inks cured with UV rays, also known as UV inks; inks cured with electron beams, also known as EB inks; and solvent-based inks.

In turn, the adhesive material used can be chosen from the group that comprises: water-based glues; glues cured with UV rays; glues cured with electron beams (EB); solvent-based glues; and solventless glues.

Therefore according to the type of inks and of adhesive material used, the treatments that can be carried out on the layer of inks and/or on the adhesive material that are applied on the segment 1a of the primary tape 1 can be for example: conventional drying with hot air, drying with UV rays, drying by irradiation with infrared (IR) rays, polymerization with electron beams (EB) and so on.

Preferably, the printing operations carried out on the segment 1a of the primary tape 1 can entail the execution of at least one digital print.

Optionally, the above printing operations can also, or alternatively, entail the execution of at least one print of the rotary type, such as for example a flexographic print, a rotogravure print, an offset print or the like.

Conveniently, the adhesive material can be applied on the segment 1a of the primary tape 1 that is in adhesion with the lateral surface of the entrainment drum 3 before proceeding with the lamination of the secondary tape 4 by way of bringing it in proximity to the segment 1a of the primary tape 1.

Alternatively, the adhesive material can also be applied on the secondary tape 4, prior to carrying out the lamination of the secondary tape with the primary tape 1.

Advantageously, there is also a step of sterilization of the laminated printed tape 5 obtained, prior to its disengagement from the entrainment drum 3.

For example, such sterilization step can be carried out by way of exposing the laminated printed tape 5 to electron beams, when it is still in contact with the entrainment drum 3.

It should be noted that the sterilization of the laminated printed tape 5 can, conveniently, be carried out by way of the same exposure to electron beams that makes it possible to carry out the drying treatment of the EB inks applied, if these are applied, or of the EB adhesive applied, if this is applied.

According to another aspect of the invention, a machine 100 is provided for manufacturing laminated printed tapes which can carry out the method according to the invention.

In particular, the machine 100 comprises an entrainment drum 3, which can rotate about its own axis and is designed to receive, so that it adheres to the lateral surface thereof, at least one segment 1a of a primary tape 1.

Conveniently, the entrainment drum 3 is rotationally actuated about its own axis by drive means, not shown, in order to allow the entrainment of the primary tape 1 along an advancement direction.

Advantageously, the entrainment drum 3 is provided with means that make it possible to maintain the segment 1a of the primary tape 1 in perfect adhesion with the lateral surface thereof and which are, for example, provided by way of a plurality of suction ports, defined on its lateral surface and connected to a vacuum pump.

Around the entrainment drum 3 and facing the segment 1a of the primary tape 1, there are the means 6 of printing the primary tape 1 and means 7 of laminating a secondary tape 4 to the primary tape 1, which are arranged downstream with respect to the printing means 6, along the advancement direction of the primary tape 1.

Advantageously, the printing means 6 comprise at least one digital printing assembly, which can be constituted, for example, by at least one digital printing head or by at least one inkjet printing head 8.

Conveniently, the printing means 6 can also be provided by at least one rotary printing assembly, which can, for example, be constituted by a flexographic printing assembly 9, made up, conveniently, by a roller plate 9a, which is designed to come into contact with the segment 1a of the primary tape 1, an anilox roller 9b, which is designed to be placed in contact with the roller plate 9a and to receive the ink from an inking unit 9c. Alternatively, the rotary printing assembly can also be provided by a rotogravure printing assembly or by an offset printing assembly or the like.

Advantageously, the lamination means 7 are provided by at least one lamination roller 10, arranged substantially parallel to the entrainment drum 3, so as to be facing, with its lateral surface, the lateral surface of the entrainment drum 3.

The lamination roller 10 is, conveniently, associated with means of feeding the secondary tape 4 which is optionally already provided with adhesive material on its face that is intended to be directed toward the primary tape 1.

Optionally, around the entrainment drum 3 there can also be means of applying a layer of adhesive material on the segment 1a of the primary tape 1, which are arranged upstream of the lamination means 7 along the advancement direction of the primary tape 1. Such applicator means can be conveniently structured in a similar manner to a rotary printing assembly, in which, instead of ink, the adhesive material is applied on the segment 1a of the primary tape 1.

Advantageously, in order to allow control of the temperature of the primary tape 1, the entrainment drum 3 is provided with means of temperature control of its lateral surface, which are, conveniently, constituted by at least one conveyance channel of a temperature control fluid, which is defined in the thickness of the side wall of the entrainment drum 3.

Conveniently, also around the entrainment drum 3, there are means 11 of treatment of the inks applied by the printing means 6 and/or of the layer of adhesive material.

The treatment means 11 can, for example, be constituted, in general, by means of drying and/or polymerizing the inks and/or the adhesive material, which are, conveniently, provided by means of emitting drying and/or polymerizing agents.

In particular, according to the type of inks and of adhesive material used, the treatment means 11 can, for example, comprise: means of emitting UV rays, which are optionally associated with a UV ray treatment apparatus 12 and/or are provided by at least one UV lamp 13; means of emitting hot air, associated, for example, with an air drying apparatus 14 and/or with one or more drying hoods 17; means of emitting electron beams, associated with an electron beam (EB) treatment assembly 15; means of emitting infrared rays, comprising, conveniently, one or more infrared lamps; and so on.

It should be noted that the entrainment drum 3 is also associated, conveniently, with a first transmission roller 16a, the function of which is to bring the primary tape 1 incoming to the entrainment drum 3 into contact with the lateral surface of the latter, and a second transmission roller 16b, which makes it possible to detach the laminated printed tape 5 obtained from the lateral surface of the entrainment drum 3.

FIG. 1 shows a first possible embodiment of the machine 100, in which the printing means 6 are constituted by a plurality of ink-jet printing heads 8, which are arranged in mutual succession, with respect to the advancement direction of the primary tape 1, and are designed to emit, in this case, UV inks.

Conveniently, in this first embodiment, UV lamps 13 are interposed between the ink-jet printing heads 8 and make possible an at least partial drying of the inks applied and, downstream of the printing heads ink-jet 8, again along the advancement direction of the primary tape 1, there can be an apparatus 12 for the UV ray treatment of the inks, which is provided in turn with lamps for emitting UV rays, and which makes it possible to complete the drying of the inks.

As can be seen in FIG. 1, downstream of such UV ray treatment apparatus 12, there is a lamination roller 10 that laminates, on the segment 1a of the primary tape 1, the secondary tape 4, which is already provided with adhesive material on the opposite face thereof from the lamination roller 10, so as to produce the laminated printed tape 5 by allowing the adhesive material to progressively take hold along the path subsequently followed by the laminated printed tape 5.

FIG. 2 shows a second embodiment of the machine 100, in which the printing means 6 are provided by a plurality of ink-jet printing heads 8 that are designed to apply water-based inks on the segment 1a of the primary tape 1.

In this case, between the ink-jet printing heads 8 there are drying hoods 17 that emit hot air toward the segment 1a of the primary tape 1 and suck it up, thus removing water vapor and thus achieving the drying of the inks.

Also in this second embodiment, downstream of the printing heads ink-jet 8 there can also be an air drying apparatus 14 which makes it possible to ensure the perfect drying of the inks prior to proceeding with the lamination of the secondary tape 4, which, in this embodiment too, is done by way of a lamination roller 10 that makes it possible to laminate the secondary tape 4, on which the adhesive material has already been applied, to the segment 1a of the primary tape 1.

With reference to FIG. 3, according to a third embodiment of the machine 100, the printing means 6 comprise a plurality of ink-jet printing heads 8 which in this case are capable of applying EB inks on the segment 1a of the primary tape 1.

In this third embodiment, the printing means can, optionally, comprise, further, one or more rotary printing assemblies, which are constituted, for example, by flexographic printing assemblies 9, designed, in this case, to apply EB inks on the segment 1a of the primary tape 1. Such rotary printing assemblies can be positioned, indifferently, downstream of the ink-jet printing heads 8, as shown in FIG. 3, or upstream thereof, along the advancement direction of the primary tape 1.

As shown in FIG. 3, downstream of the printing means 6, along the advancement direction of the primary tape 1, there is a lamination roller 10, which, as in the previous cases, laminates the secondary tape 4, already provided with adhesive material, which, in this case, can be advantageously constituted by an EB adhesive, to the segment 1a of the primary tape 1.

Also according to the third embodiment, downstream of the lamination roller 10, along the advancement direction of the primary tape 1, there is an electron beam (EB) treatment assembly 15 arranged facing toward the lateral surface of the entrainment drum 3, so as to act on the laminated printed tape 5 in output from the lamination roller 10, in order to carry out the drying of the EB inks applied by the printing means 6, the polymerization of the EB adhesive used, and the sterilization of the laminated printed tape 5.

From the foregoing it can be seen that the invention is capable of fully achieving the set aim and objects.

One advantage of the method and of the machine according to the invention is that it makes it possible to wind on reels printed primary tapes with the secondary tape already laminated on their face on which the inks have been applied, thus preventing the inks from contaminating the opposite face of that primary tape.

All the characteristics of the invention, indicated above as advantageous, convenient or similar, may also be missing or be substituted by equivalent characteristics.

The individual characteristics set out in reference to general teachings or to specific embodiments may all be present in other embodiments or may substitute characteristics in such embodiments.

The invention thus conceived is susceptible of numerous modifications and variations, all of which are within the scope of the appended claims.

In practice the materials employed, provided they are compatible with the specific use, and the dimensions and shapes, may be any according to requirements.

Moreover, all the details may be substituted by other, technically equivalent elements.

The disclosures in Italian Patent Application No. 102016000083243 (UA2016A005979) from which this application claims priority are incorporated herein by reference.

1-17. (canceled)

18. A method for manufacturing laminated printed tapes, comprising the steps of:
causing the advancement of a primary tape, making it adhere, with at least one segment thereof, to the lateral surface of an entrainment drum;
performing at least one printing operation with application of at least one layer of ink on at least one portion of said segment of said primary tape in adhesion with a lateral surface of said entrainment drum; and
subsequently laminating, on said segment of said primary tape in adhesion with a lateral surface of said entrainment drum, a secondary tape by way of the interposition of adhesive material, so as to obtain a laminated printed tape.

19. The method according to claim 18, wherein it provides for controlling the temperature at least of the segment of said primary tape in adhesion with the lateral surface of said entrainment drum by way of the temperature control of said entrainment drum.

20. The method according to claim 18, wherein at least one treatment is performed, at said segment of said primary tape in adhesion with said entrainment drum, on said at least one layer of ink and/or on said adhesive material.

21. The method according to claim 20, wherein said at least one treatment comprises at least one step of drying and/or polymerizing said at least one layer of ink and/or said adhesive material.

22. The method according to claim 18, wherein said at least one printing operation entails the execution of at least one digital print.

23. The method according to claim 22, wherein said at least one printing operation entails the execution of at least one print of the rotary type.

24. The method according to claim 18, wherein it entails the application of said adhesive material to said segment of said primary tape in adhesion with the lateral surface of said entrainment drum.

25. The method according to claim 18, wherein it entails the application of said adhesive material to said secondary tape before laminating said secondary tape to said primary tape.

26. The method according to claim 18, wherein it entails the execution of a sterilization of the resulting laminated printed tape prior to its disengagement from said entrainment drum.

27. A machine for manufacturing laminated printed tapes, comprising an entrainment drum that can rotate about its own axis and is adapted to receive in adhesion, on a lateral surface thereof, a primary tape, around said entrainment drum there being means of printing said primary tape and means of laminating a secondary tape to said primary tape, said laminating means being arranged downstream with respect to said printing means along an advancement direction of said primary tape.

28. The machine according to claim 27, wherein said printing means comprise at least one digital printing assembly.

29. The machine according to claim 27, wherein said printing means comprise at least one rotary printing assembly.

30. The machine according to claim 27, wherein said laminating means are adapted to laminate said secondary tape to said primary tape by way of the interposition of adhesive material.

31. The machine according to claim 27, wherein said laminating means comprise at least one lamination roller which is arranged so as to face, with a lateral surface thereof, the lateral surface of said entrainment drum and is adapted to engage said secondary tape in order to laminate it to a segment of said primary tape in adhesion with the lateral surface of said entrainment drum.

32. The machine according to claim 27, wherein said entrainment drum is provided with means of controlling the temperature of its lateral surface.

33. The machine according to claim 27, further comprising, around said entrainment drum, means of applying a layer of adhesive material to said primary tape, said means of applying being arranged upstream with respect to said laminating means, along the advancement direction of said primary tape.

34. The machine according to claim 30, further comprising, around said entrainment drum, means of treatment of inks applied by said printing means on said primary tape and/or of said adhesive material.
